(19) United States
(12) Patent Application Publication
(10) Pub. No.: US 2006/0117885 A1
(43) Pub. Date: Jun. 8, 2006

(54) Actuator

(76) Inventors: Martin Robson, Tyabb (AU); David Ellis, Carrum Downs (AU); Eric P. Willmot, Mount Eliza (AU); Mark H Geer, South Caulfield (AU)

Correspondence Address: THE WEBB LAW FIRM, P.C., 700 KOPPERS BUILDING, 436 SEVENTH AVENUE, PITTSBURGH, PA, 15219, US

(21) Appl. No.: 10/533,855

(22) PCT Filed: Nov. 25, 2002
(86) PCT No.: PCT/AU02/01585

§ 371 Date: May 4, 2005

(30) Foreign Application Priority Data
Dec. 21, 2001 (AU) PR 9722
Apr. 5, 2002 (AU) PS 1565

(51) Int. Cl. F16H 1/20

(52) U.S. Cl. 74/413

(57) ABSTRACT

An actuator such as a vehicle hand brake actuator is disclosed. The actuator includes an electric motor (18) which drives an orbital gear box (20) which in turn has an output connected to a pulley (60) for applying a load to cables (62) to apply the brake. A pinion gear (24) is mounted on the output of the motor (18) and drives a pinion gear (27) which in turn meshes with a spur gear (30) connected to input shaft (36) an eccentric (42) for driving the gear box (20). The orbital gear box (20) has orbit gears (50, 52) which are fixed together and which have a different number of teeth to provide a gear ratio. The gear (52) meshes with an output gear (56) which in turn is fixed to the pulley (60).

### FIELD OF THE INVENTION

This invention relates to an actuator and, in particular, but not exclusively, to an actuator for a vehicle hand-brake.

### BACKGROUND OF THE INVENTION

Actuators used in many environments are generally in the form of hydraulic devices in which hydraulic fluid needs to be supplied in order to operate the actuator. This requires bleeding of hydraulic lines and also a significant amount of maintenance to maintain the hydraulic system.

Hand brakes used in vehicles are generally mechanical devices which are manually operated and also require maintenance to adjust the hand brake from time to time.

The object of the present invention is to provide an actuator which does not require adjustment in order to maintain the operation of the actuator and which also does not require hydraulic fluid to operate the actuator.

### SUMMARY OF THE INVENTION

The present invention may be said to reside in an actuator including:
an electric motor having a motor output;
an orbital transmission having:
(a) an eccentric;
(b) a first orbit gear mounted on the eccentric;
(c) a second orbit gear mounted for rotation on the eccentric and fixed to the first orbit gear;
(d) a first outer gear for meshing with the first orbit gear; and
(e) a second outer gear for meshing with the second orbit gear;
one of the eccentric and first outer gear forming an input to the orbital transmission, and one of the second outer gear and eccentric respectively, forming an output from the orbital transmission; and
an output member coupled to the output of the orbital transmission for applying a load.

Thus, because the actuator utilises an electric motor and a gear system formed by the orbital transmission, adjustment is not required because the motor will always be driven to move the actuator between a load applying condition and a released condition and, furthermore, no hydraulic fluid is required in order to drive the actuator and apply a load by the actuator.

Preferably the eccentric forms the input to the orbital transmission and the second outer gear forms the output from the orbital transmission.

Preferably the output member comprises a kidney pulley coupled to the output of the orbital transmission, the kidney pulley receiving a cable so that upon rotation of the kidney pulley in one direction, a load is applied to the cable, and upon rotation of the kidney pulley in the opposite direction, the load is released from the cable.

Preferably the first outer gear is arranged in a gear housing, the housing receiving an input shaft which couples with the eccentric and the input shaft mounting the spur gear so that upon rotation of the spur gear, the input shaft and the eccentric are rotated.

Preferably the housing and first input gear are fixed stationary relative to the input shaft and the eccentric and provide a control gear so that when the eccentric is rotated, the first orbit gear is caused to execute an orbit, which in turn causes the second orbit gear to execute an orbit, and the meshing of the second orbit gear with the second output gear, rotates the second output gear, to in turn rotate the kidney pulley.

Preferably the second output gear carries at least one sensor for sensing rotary movement of the second output gear, and therefore rotary movement of the kidney pulley.

The present invention may also be said to reside in an actuator including:
an electric motor having a motor output;
an orbital transmission having:
(a) an eccentric;
(b) a first orbit gear mounted on the eccentric;
(c) a second orbit gear mounted for rotation on the eccentric and fixed to the first orbit gear;
(d) a first outer gear for meshing with the first orbit gear; and
(e) a second outer gear for meshing with the second orbit gear;
one of the eccentric and first outer gear forming an input to the orbital transmission, and one of the second outer gear and eccentric respectively, forming an output from the orbital transmission;
an output member coupled to the output of the orbital transmission for applying a load; and
a spur gear arrangement between the motor output and the input of the orbital transmission, and including a spur gear coupled to the input of the orbital transmission, and a pinion gear system meshing with the spur gear and driven by the motor output of the electric motor.

Thus, because the actuator utilises an electric motor and a gear system formed by the orbital transmission and the spur gear arrangement, adjustment is not required because the motor will always be driven to move the actuator between a load applying condition and a released condition and, furthermore, no hydraulic fluid is required in order to drive the actuator and apply a load by the actuator.

This aspect of the invention has particular application to orbital gear box which are not particularly efficient and therefore may require assistance in being moved to an “unlocked” condition.

The combination of the orbital transmission and the spur gear arrangement of the present invention enables the actuator to apply a load and to be locked upon rotation of the motor in one direction because of the inherent nature of the orbital gear box which allows for rotation in one direction, but resists rotation in the reverse direction. This therefore enables a load to be applied and for the load to be locked on and held by the actuator. When it is desired to release the load, the electric motor is rotated in the opposite direction so that the gear ratio advantage supplied by the spur gear is able to supply sufficient torque to drive the orbital transmission in the reverse direction against the tendency of the orbital transmission to resist rotation in that direction, and therefore unlock the actuator to release the load.

Preferably the actuator includes a control section including current limiting means for limiting the current supplied to the motor when the electric motor is to be rotated in the direction to cause the actuator to apply the load, and for supplying a higher current when the electric motor is to be rotated in the second direction to cause the actuator to remove the load.

Thus, in accordance with this preferred embodiment, the use of the spur gear arrangement reduces the speed of the input rotation to the orbital gear box and increases the amount of torque to rotate the gear box and apply the load. Because of the increased torque supplied by the gear reduction, the amount of current required to drive the electric motor can be reduced. This has the advantage of ensuring that the amount of torque supplied from the motor and increase by the gear reduction ratio does not lock the orbital transmission when the transmission is loaded so that it is extremely difficult, if not impossible, to reverse rotation of the orbital gear box. When it is desired to rotate the motor in a reverse direction, and consequently rotate the orbital transmission in the reverse direction to release the load, the current can be increased and, together with the gear ratio supplied by the spur gear arrangement, results in an extremely high torque supplied to the orbital transmission for rotating the orbital transmission in the reverse direction to thereby provide for the reverse rotation and release of the load.

Preferably the eccentric forms the input to the orbital transmission and the second outer gear forms the output from the orbital transmission.

Preferably the pinion gear system comprises a first pinion mounted on the motor output, a second pinion in mesh with the first pinion, and the second pinion meshing with the spur gear.

In another embodiment, the spur gear arrangement comprises a spur gear having internal teeth and a pinion mounted on the motor output and meshing with the internal teeth of the spur gear.

However, in other embodiments, a single pinion could be mounted on the motor output and mesh with the spur gear.

Preferably the output member comprises a kidney pulley coupled to the output of the orbital transmission, the kidney pulley receiving a cable so that upon rotation of the kidney pulley in one direction, a load is applied to the cable, and upon rotation of the kidney pulley in the opposite direction, the load is released from the cable.

Preferably the first outer gear is arranged in a gear housing, the housing receiving an input shaft which couples with the eccentric and the input shaft mounting the spur gear so that upon rotation of the spur gear, the input shaft and the eccentric are rotated.

Preferably the housing and first input gear are fixed stationary relative to the input shaft and the eccentric and provide a control gear so that when the eccentric is rotated, the first orbit gear is caused to execute an orbit, which in turn causes the second orbit gear to execute an orbit, and the meshing of the second orbit gear with the second output gear, rotates the second output gear, to in turn rotate the kidney pulley.

Preferably the second output gear carries at least one sensor for sensing rotary movement of the second output gear, and therefore rotary movement of the kidney pulley.

Preferably the motor and the orbital gear box are arranged in side by side relationship within a casing.

The invention may also be said to reside in a brake applicator for a vehicle, including:
a brake system for applying the brakes of a vehicle;
a cable connected to the brake system; and
a brake actuator engaging the cable for drawing in the cable to apply the brakes or feeding out the cable to release the brakes, the brake applicator having:
(a) an electric motor having a motor output;
(b) an orbital transmission having an input coupled to the motor so that the input can be driven by the motor;
(c) an output from which output rotary power is supplied; and
(d) an output pulley engaging the cable and connected to the output so that when the output rotates in one direction, the cable is drawn in to apply the brakes, and when rotated in the opposite direction, is paid out to release the brakes.

Thus, once again, this aspect of the invention provides an actuator which does not require adjustment and also does not require hydraulic fluid.

Preferably the orbital transmission comprises:
(a) an eccentric;
(b) a first orbit gear mounted on the eccentric;
(c) a second orbit gear mounted for rotation on the eccentric and fixed to the first orbit gear;
(d) a first outer gear for meshing with the first orbit gear; and
(e) a second outer gear for meshing with the second orbit gear;
one of the eccentric and first outer gear forming an input to the orbital transmission, and one of the second outer gear and eccentric respectively, forming an output from the orbital transmission; and
an output member coupled to the output of the orbital transmission for applying a load.

In one embodiment, the brake actuator further includes a spur gear arrangement between the motor output and the input of the orbital transmission, and including a spur gear coupled to the input of the orbital transmission, and a pinion gear system meshing with the spur gear and driven by the motor output of the electric motor.

Preferably the eccentric forms the input to the orbital transmission and the second outer gear forms the output from the orbital transmission.

Preferably the pinion gear system comprises a first pinion mounted on the motor output, a second pinion in mesh with the first pinion, and the second pinion meshing with the spur gear.

In another embodiment, the spur gear arrangement comprises a spur gear having internal teeth and a pinion mounted on the motor output and meshing with the internal teeth of the spur gear.

However, in other embodiments, a single pinion could be mounted on the motor output and mesh with the spur gear.

Preferably the output member comprises a kidney pulley coupled to the output of the orbital transmission, the kidney pulley receiving a cable so that upon rotation of the kidney pulley in one direction, a load is applied to the cable, and upon rotation of the kidney pulley in the opposite direction, the load is released from the cable.

Preferably the first outer gear is arranged in a gear housing, the housing receiving an input shaft which couples with the eccentric and the input shaft mounting the spur gear so that upon rotation of the spur gear, the input shaft and the eccentric are rotated.

Preferably the housing and first input gear are fixed stationary relative to the input shaft and the eccentric and provide a control gear so that when the eccentric is rotated, the first orbit gear is caused to execute an orbit, which in turn causes the second orbit gear to execute an orbit, and the meshing of the second orbit gear with the second output gear, rotates the second output gear, to in turn rotate the kidney pulley.

Preferably the second output gear carries at least one sensor for sensing rotary movement of the second output gear, and therefore rotary movement of the kidney pulley.

### BRIEF DESCRIPTION OF THE DRAWINGS

A preferred embodiment of the invention will be described, by way of example, with reference to the accompanying drawings in which:

FIG. 1 is an exploded view of an actuator which is to be used as a hand brake for a vehicle, according to the preferred embodiment of the invention;

FIG. 2 is an end view of an assembled actuator according to the preferred embodiment of the invention;

FIG. 3 is a view along the line III-III of FIG. 2;

FIG. 4 is a block circuit diagram of a controller for use with the preferred embodiments;

FIG. 5 is a perspective view of another embodiment;

FIG. 6 is a cross-sectional view of the embodiment of FIG. 5;

FIG. 7 is a cross-sectional view through a further embodiment of the invention; and

FIG. 8 is a front view of the applicators of FIGS. 1 and 7 in a vehicle hand brake.

### DESCRIPTION OF THE PREFERRED EMBODIMENTS

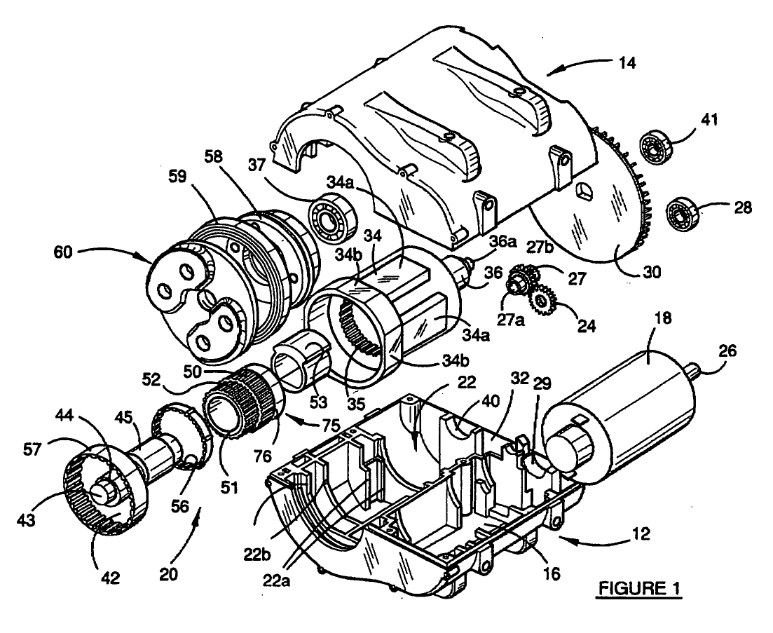

A preferred embodiment of the invention is described with reference to FIGS. 1 to 3. Referring first to FIG. 1, the preferred embodiment includes casing parts 12 and 14. The casing parts 12 and 14 form a first cavity 16 which houses an electric motor 18. An orbital transmission 20 is mounted in a second cavity 22 within the casing parts 12 and 14. A first pinion gear 24 is mounted on output shaft 26 of the motor 18 and the output shaft 26 is supported by a bearing 28 which seats in recess 29 formed in the casing 12 and 14.

The pinion gear 24 meshes with a pinion gear 27 which in turn meshes with a spur gear 30. The pinion gear 27 has bushes 27a and 27b which locate in grooves 32 in the casing parts 12 and 14. Two pinion gears are used in the preferred embodiment of the invention simply to bridge the distance between the output shaft 26 of the motor 18 and the spur gear 30 and to provide a gear reduction of about 5 to 1 from the motor 18 to the spur gear 30. However, depending on the reduction which is required, a single pinion could be mounted on the shaft 26 and mesh with the spur gear 30, or more than two pinion gears could be provided.

The orbital transmission 20 includes a control gear housing 34 which sits in the recess 22 and has flats 34a and 34b which locate against flats 22a and 22b in the housing parts 12 and 14 to locate the housing 34 fixed and stationary within the assembled casing parts 12 and 14.

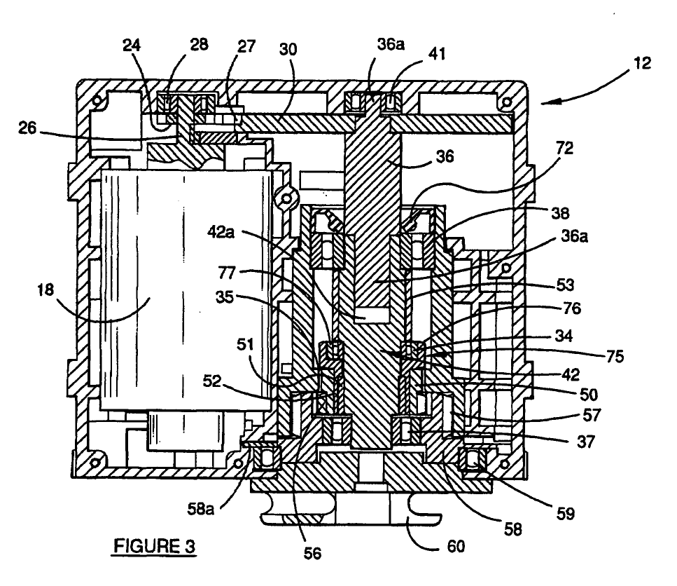

An input shaft 36 is supported in the housing 34 on a bearing 38 locating in the housing 34 (and shown in FIG. 3). The spur gear 30 locates on the input shaft 36, and the tip end 36a of the input shaft 36 is supported in recess 40 of the casing 12 and 14 by a bearing 41.

The input shaft 36 is secured to an eccentric 42 by a hexagonal stem 36a (shown in FIG. 3) which locates in a hexagonal bore 42a (also shown in FIG. 3) provided in the eccentric 42. As is also shown in FIG. 3, the eccentric is supported in a bearing 38 which is provided in the housing 34 and a seal 72 locates in the housing 34 and over the bearing 38 to seal the housing 34. The eccentric 42 has a rotation axis 43 and an eccentricity 44 formed on the rotation axis 43. A lobe 45 is also provided on the eccentric 42. An orbit gear assembly 72 is mounted on the eccentric 44 and comprises a carrier 76 which is journaled for rotation on the eccentric 43 by bearing 77 (shown in FIG. 3) and bush 51. A first orbit gear 50 and a second orbit gear 52 are fixed together and secured to the carrier 76. The gears 50 and 52 have a different number of teeth to provide a gear ratio.

The housing 34 has an integral control gear 35 and the first orbit gear 50 meshes with the control gear 35. The second orbit gear 52 meshes with an output gear 56 which is supported in a bearing 57. The output gear 56 is fixed to an output shaft 58 which is in turn supported in a bearing 59. A kidney pulley 60 is coupled to the output shaft 58 for rotation with the output ring gear 56, and the output shaft 58.

The number of teeth provided on the control gear 35, the first orbit gear 50, the second orbit gear 52 and the output gear 56 are chosen to provide a predetermined reduction ratio of, for example, 300 to 1.

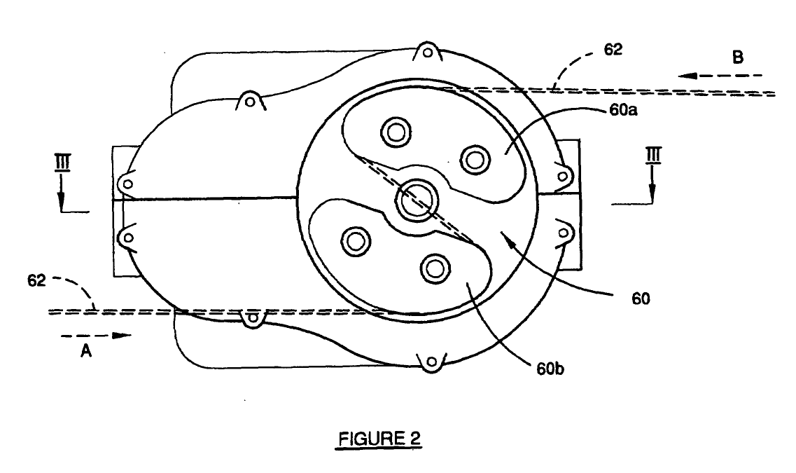

The kidney pulley 60 is of known design and therefore will not be disclosed in any further detail. However, with reference to FIG. 2, it can be seen that the kidney pulley 60 receives a cable 62 which extends about one lobe 60a of the kidney pulley 60 and then across the diameter of the kidney pulley 60 to extend about the other lobe 60b of the kidney pulley 60. As will be apparent from FIG. 2, if the kidney pulley 60 is rotated in a counterclockwise direction, the cable 62 is pulled inwardly in the direction of arrows A and B in FIG. 2 to thereby apply a load to the cable 62 which can be used to apply a vehicle brake. When the kidney pulley 60 is rotated in a clockwise direction, the load is released from the cable 62 so that it can move outwardly in the direction opposite arrow A and B so as to release the load applied by the cable 62 and therefore release the brake of the vehicle.

Operation of the hand brake actuator will be described in further detail with reference to FIG. 3.

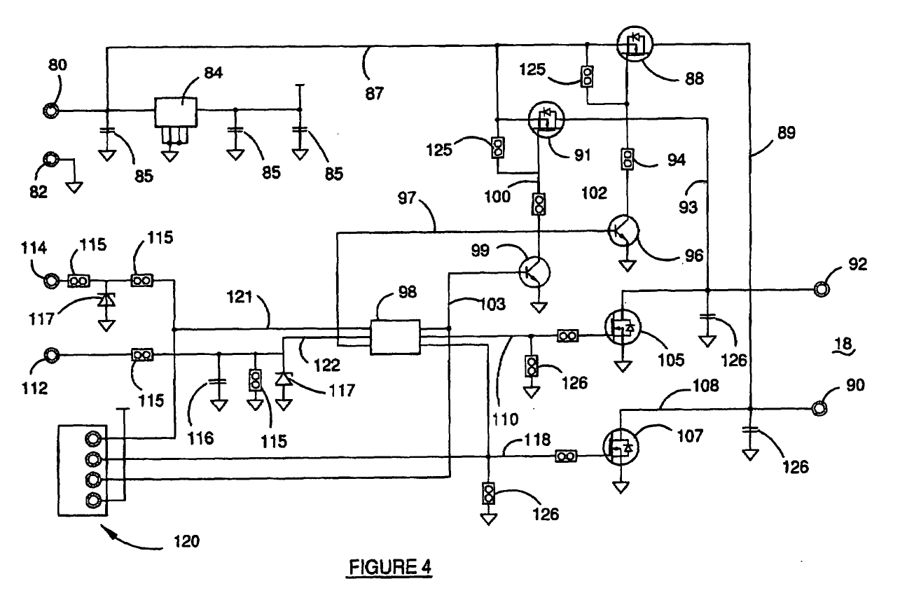

Referring firstly to FIG. 4, when current is supplied to motor 18, the motor is rotated so that motor output shaft 26 rotates to in turn rotate pinion gear 24. Pinion gear 24 meshes with pinion gear 27 and therefore rotates pinion gear 27. Pinion gear 27 is in mesh with spur gear 30 and therefore rotates spur gear 30. Rotation of the spur gear 30 rotates the input shaft 36 which in turn rotates the eccentric 42. As the eccentric rotates, the gear 50 is caused to execute an orbit because it meshes with stationary control gear 35 and can rotate on the eccentric 44. This, in turn, causes the second orbit gear 52 to also execute an orbit because the gears 50 and 52 are fixed together in the manner previously described. As the second spur gear 52 orbits, it supplies drive to second ring gear 56, which rotates the ring gear 56 and also the output shaft 58 to which the ring gear 56 is mounted. This rotation is imparted to the kidney pulley 60 to in turn rotate the kidney pulley 60.

The orbital gear box arrangement described above is more fully disclosed in our co-pending International Application No. PCT/AU97/00443, the contents of which are incorporated into this specification by this reference. This International application also describes the preferred gear profile which should be used to create the teeth of the orbital transmission formed by the control gear 35, first orbit gear 50, second orbit gear 52 and output gear 56.

The output shaft 58 may also carry an outer disc 58a which is integral with the output shaft 58 and which can be provided with sensors for monitoring the rotation of the output shaft 58 and therefore the kidney pulley 60.

The preferred embodiment also includes a control circuit for supplying current to the motor 18 to drive the motor 18. The current to drive the motor 18 may be supplied via the vehicle battery. However, auxiliary batteries are also coupled to the motor 18 for driving the motor 18 in the event that the vehicle battery goes flat. This therefore enables the hand brake to be released if the battery is flat by power supplied from the auxiliary battery.

The control circuit allows for a reduced amount of current to be supplied to the motor 18 when it is desired to rotate the orbital transmission in a direction, such as the counterclockwise direction previously described, to apply the load, or if the actuator is a vehicle brake actuator, to apply the vehicle brakes.

In view of the reduction supplied by the spur gear arrangement, the amount of torque which is supplied to the orbital transmission to rotate the orbital transmission is high, thereby enabling the transmission to rotate to apply the load without maximum torque supply from the motor 18. This in turn ensures that the amount of torque at the output of the transmission is not so high as to cause the transmission to lock on very hard when the load is applied, to thereby make it very difficult, if not impossible, to rotate the transmission in the reverse direction to release the load. This feature of the transmission locking is caused by the engagement process in orbital transmission which is not a rolling motion as in convention spur-type gear systems. The engagement process in orbital transmissions is a radial movement of the gears relative to one another and if the transmission is stopped while under significant load, the meshing teeth will tend to remain in the engagement process and resist movement out of engagement because of the load applied to the transmission. Thus, when the transmission is loaded, such as occurs when the hand brake is applied, the transmission locks in a stationary position and simply will not rotate in the reverse direction due to the load applied to the transmission. Thus, this holds the hand brake on. When it is desired to release the load, the amount of current supplied by the control circuitry to the motor can be increased to the maximum current to thereby increase the amount of torque supplied by the motor 18, which again is amplified by the spur gear arrangement, to thereby provide a significantly higher amount of torque to the orbital transmission to rotate the orbital transmission in the reverse direction against the locking tendency of orbital transmissions so that the load can be released.

When the hand brake is released, no load is supplied to the gear box and therefore when it is desired to again apply the hand brake, the orbital transmission 20 can be easily rotated in the required direction. Because no load is applied when the hand brake in the released or off stole transmission does not have the same degree of locking as when the hand brake is on and load is therefore applied to the transmission.

FIG. 4 shows a diagram of a controller for controlling the motor 18. Power is supplied to the circuit in FIG. 4 from the vehicle battery (not shown) which is connected to terminals 80 and 82. Auxiliary batteries (not shown) may also be coupled to the terminals 80 and 82, for the reason previously described. The terminals 80 and 82 are connected to a power conversion chip 84 for converting the input voltage (such as a 12 volt supply) to a 5 volt supply for supplying power to processor 86 via a pin (not shown) on the processor 98. Capacitors 85 smooth the power supply.

Terminal 80 is also connected to line 87 which includes field effect transistor 88. The other side of the field effect transistor 88 is connected by line 89 to one of the terminals 90 which will be connected to the motor 18. Line 87 is also connected to field effect transistor 91 which is connected by line 93 to the other terminal 92 of the motor 18.

The transistor 88 is also connected via resistor 94 to a transistor 96 and the transistor 96 is connected to processor 98 via line 97. The transistor 91 is also connected to transistor 99 via line 100 and resistor 102 and the transistor 99 is connected to the processor 98 via line 103. Field effect transistor 105 is also connected to the terminal 92 via line 106 and field effect transistor 107 is connected to terminal 90 by line 108. The field effect transistors 105 and 107 are also connected to the processor 98 by lines 110 and 111 respectively.

A brake release and actuate terminal 112 is coupled to the brake actuator in the vehicle, which may simply be a button or other input control which can be manually actuated by a driver or, in turn, automatically actuated when a vehicle is placed in park in the case of an automatic transmission. This terminal receives a voltage every time the condition of the park brake changes from an on condition to an off condition. Terminal 114 is also connected to the park brake and provides a signal indicative of the state of the park brake. For example, when the park brake is on, a nominally 12 volt signal may be supplied to the terminal 114 and when the park brake is off, a 0 volt signal is supplied to the terminal 114. Resistors 115 and diodes 117 provide over voltage input protection for the processor 98. Capacitor 116 provides noise filtering for the hand brake signal.

The processor 98 also is supplied with an in circuit programming interface 120 which does not perform any function in relation to the preferred embodiment, but is simply provided to enable the processor 98 to be reprogrammed, should that be necessary or desired.

Assuming that the hand brake is off, the processor 98 receives a 0 volt signal on line 121 from terminal 114 to indicate to the processor 98 that the hand brake is in the off position. When it is desired to apply the hand brake, a 5 volt signal is supplied on line 112 and this signal is received by the processor 98 on line 122. Thus, by the signals on lines 121 and 122, the processor is able to determine the state of the hand brake and also the desire to change the state of the hand brake (such as to apply the hand brake in the present example). The processor 98 outputs a voltage on line 97 to transistor 96, which switches the transistor 96 on. This in turn drives the transistor 88 so that voltage is supplied on line 89 to terminal 90. Similarly, an output is provided from the processor 98 on line 110 to drive transistor 105 on, so that terminal 92 is effectively connected to ground. Thus, power is supplied across the motor 18 to operate the motor 18 in one direction to put the hand brake on. The signal supplied from the processor 98 on line 110 is a pulse width modulated signal which toggles the transistor 105 on and off so that the current which is supplied from the transistor 88 on line 89 to the terminal 90 is reduced to therefore provide the reduced current supply to turn the hand brake on as previously described. The current may be reduced to 50% of that which would be supplied if the transistor 105 was held permanently on so that the motor 16 supplies sufficient torque to operate the hand brake, but not over-lock the hand brake in view of the load which the orbital transmission will experience when the hand brake of the vehicle is applied. When the hand brake is applied, the signal on line 114 changes state so that the processor 98 then knows the state of the hand brake (ie. the hand brake being on). The processor 98 outputs the signals on the line 97 and 110 for a predetermined time interval sufficient to drive the motor to apply the hand brake and then those signals are stopped once the hand brake is applied.

When it is desired to release the hand brake, a signal is supplied to terminal 112 by manual actuation of the hand brake button or by simple movement of the vehicle out of park so that the processor receives a signal on line 122 indicative of the need to change the condition of the brake. The processor 98 knows that the hand brake is on because of the signal on line 121 and therefore the logic in the chip 98 outputs the appropriate signals to cause the hand brake to be released. These signals comprise an output on line 103 which switches transistor 99 on to drive field effect transistor 91. This therefore connects the terminal 92 to the power supply line 87. Simultaneously, a signal is output on line 111 to drive transistor 107 and effectively connect the terminal 92 ground. Since the hand brake is being released, the power supplied to the motor 18 need not be toggled and therefore the full current from line 87 is supplied to the terminal 92 to fully drive the motor 18 in the opposite direction to release the hand brake.

The resistors 125, which are parallel to the transistors 91 and 88, allow the transistors 91 and 88 to discharge when the transistors are switched off. The resistors 126 are provided to hold the transistors 105 and 107 in an off state when the processor 98 is first powered up to prevent those transistors from switching on during initial powering up of the processor 98. The capacitors 126 merely filter noise from the power supplied to the terminals 90 and 92.

Thus, the circuit described with reference to FIG. 4 is able to supply full current to the motor 18 when it is desired to release the hand brake and to provide reduced current to the motor 18 when the hand brake is applied for the reasons which are specified above.

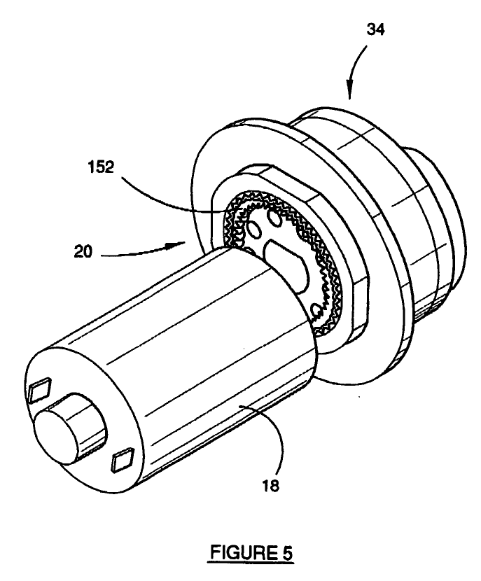

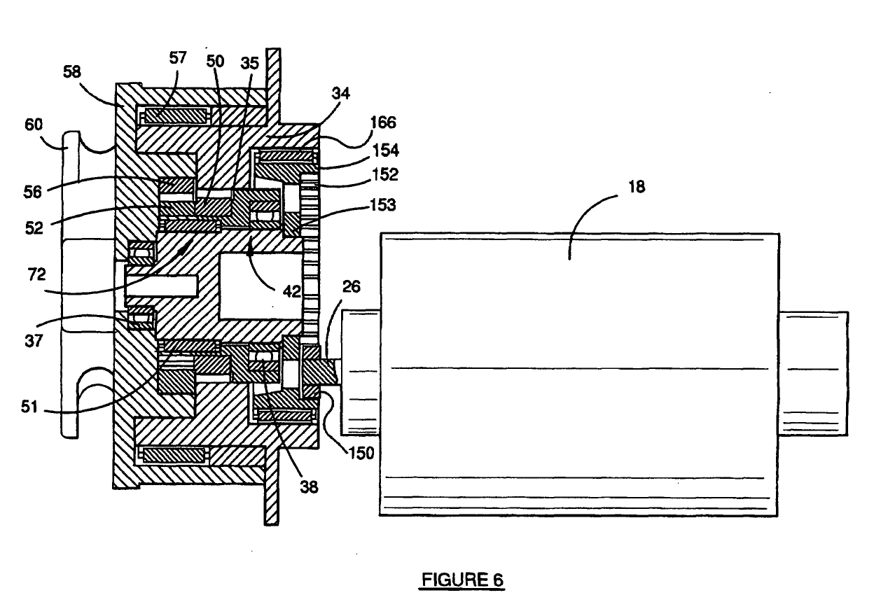

FIGS. 5 and 6 show a second embodiment of the invention. In this embodiment, FIG. 5 shows a perspective view and like reference numerals indicate like parts to those previously described. In this embodiment, the output shaft 26 of the motor 18 carries pinion 150 which meshes with a spur gear 152 which is provided with internal teeth. The spur gear 152 is connected to input 154 which is provided with a plurality of holes 156 and the input 154 is connected to eccentric shaft 42 by D-connection illustrated by reference 153 between the input 154 and the eccentric 42. Orbit gear assembly 72 is mounted on the eccentric 42 in the same manner as previously described and includes the orbit gears 50 and 52 as previously described. The gear 50 meshes with a stationary gear 35 provided on fixed housing 34, and gear 52 meshes with output ring gear 56 which is coupled to output 58. The kidney pulley 60 is mounted on the output 58 as in the earlier embodiment.

In this embodiment, the shape of the housing 34 and the output 58 are slightly different, as is shown in FIG. 6, and the output 58 is supported on the housing 38 by the bearing 57 and also a bush 160.

In this embodiment the input 154 is mounted within the housing 34 and a roller bearing 166 so as to allow for rotation of the spur gear 152 and the input 154 relative to the housing 34.

This embodiment operates in exactly the same manner as the embodiment of FIG. 1, with the main difference being that the spur arrangement is an internal spur provided by the pinion 150 meshing with internal teeth on the spur gear 154 instead of the spur arrangement shown with reference to FIG. 1. This embodiment is controlled by the control circuitry of FIG. 4 in the same manner as previously described.

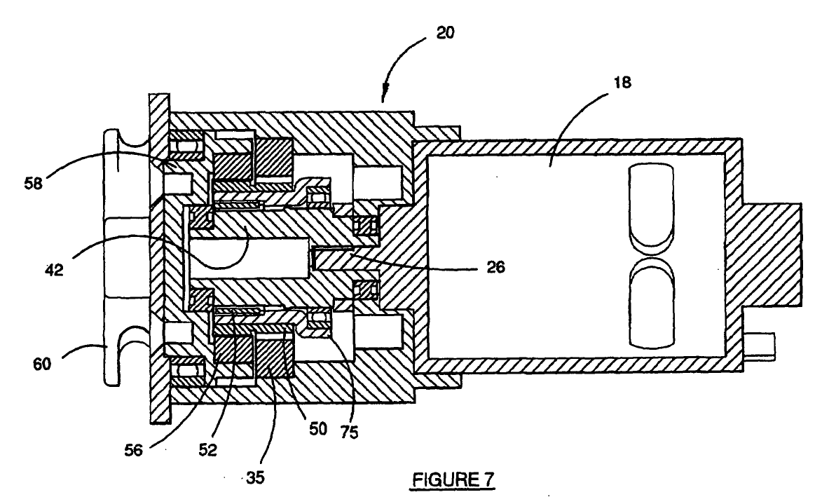

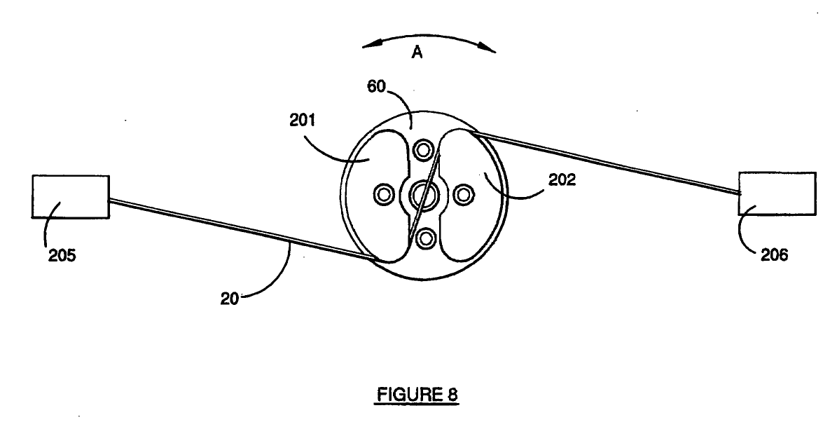

FIGS. 7 and 8 show a further embodiment of a vehicle hand brake in which the spur gear and pinion previously described are omitted and the orbital gear box 20 is driven directly by the motor 18. In this embodiment, the motor 18 has output shaft 26 which couples directly with eccentric 42 of the orbital gear box 20 for rotating the eccentric. The structure of the orbital gear box 20 is the same as that previously described, and therefore will not be disclosed in further detail hereinafter. The same reference numerals in FIG. 7 indicate like parts to those described with reference to FIG. 1.

As is shown in FIG. 8, kidney pulley 60 engages a cable 200 which passes around one lobe 201 of the pulley 60, diametrically across the pulley 60, and then around the other lobe 202 of the pulley 60. One end of the cable 20 is connected to a first brake system 205, and the other to a second brake system 206 for, for example, applying the rear brakes of a vehicle when the vehicle is parked.

As previously described, when the electric motor 18 is actuated, the transmission 20 is driven to rotate the pulley 60 in the direction of double-headed arrow A in FIG. 8. Rotation to the right, or in a clockwise direction in FIG. 8 will cause the cable 20 to be paid out from the pulley 60, thereby releasing the brakes 205 and 206. When the pulley 60 is rotated in the opposite direction (ie. in the counterclockwise direction), the cable 20 is pulled in towards the pulley 60, thereby applying the vehicle brakes 205 and 206. The brakes 205 and 206 are conventional and therefore they need not be described in any further detail.

The control circuitry for controlling the embodiment of FIGS. 7 and 8 is the same as that described with reference to FIG. 4.

Since modifications within the spirit and scope of the invention may readily be effected by persons skilled within the art, it is to be understood that this invention is not limited to the particular embodiment described by way of example hereinabove.

1. An actuator including:
an electric motor having a motor output;
an orbital transmission having:
(a) an eccentric;
(b) a first orbit gear mounted on the eccentric;
(c) a second orbit gear mounted for rotation on the eccentric and fixed to the first orbit gear;
(d) a first outer gear for meshing with the first orbit gear; and
(e) a second outer gear for meshing with the second orbit gear;
one of the eccentric and first outer gear forming an input to the orbital transmission, and one of the second outer gear and eccentric respectively, forming an output from the orbital transmission; and
an output member coupled to the output of the orbital transmission for applying a load.

2. The actuator of claim 1 wherein the eccentric forms the input to the orbital transmission and the second outer gear forms the output from the orbital transmission.

3. The actuator of claim 1 wherein the output member comprises a kidney pulley coupled to the output of the orbital transmission, the kidney pulley receiving a cable so that upon rotation of the kidney pulley in one direction, a load is applied to the cable, and upon rotation of the kidney pulley in the opposite direction, the load is released from the cable.

4. The actuator of claim 1 wherein the first outer gear is arranged in a gear housing, the housing receiving an input shaft which couples with the eccentric and the input shaft mounting the spur gear so that upon rotation of the spur gear, the input shaft and the eccentric are rotated.

5. The actuator of claim 4 wherein the housing and first input gear are fixed stationary relative to the input shaft and the eccentric and provide a control gear so that when the eccentric is rotated, the first orbit gear is caused to execute an orbit, which in turn causes the second orbit gear to execute an orbit, and the meshing of the second orbit gear with the second output gear, rotates the second output gear, to in turn rotate the kidney pulley.

6. The actuator of claim 5 wherein the second output gear carries at least one sensor for sensing rotary movement of the second output gear, and therefore rotary movement of the kidney pulley.

7. An actuator including:
an electric motor having a motor output;
an orbital transmission having:
(a) an eccentric;
(b) a first orbit gear mounted on the eccentric;
(c) a second orbit gear mounted for rotation on the eccentric and fixed to the first orbit gear;
(d) a first outer gear for meshing with the first orbit gear; and
(e) a second outer gear for meshing with the second orbit gear;
one of the eccentric and first outer gear forming an input to the orbital transmission, and one of the second outer gear and eccentric respectively, forming an output from the orbital transmission;
an output member coupled to the output of the orbital transmission for applying a load; and
a spur gear arrangement between the motor output and the input of the orbital transmission, and including a spur gear coupled to the input of the orbital transmission, and a pinion gear system meshing with the spur gear and driven by the motor output of the electric motor.

8. The actuator of claim 7 wherein the actuator includes a control section including current limiting means for limiting the current supplied to the motor when the electric motor is to be rotated in the direction to cause the actuator to apply the load, and for supplying a higher current when the electric motor is to be rotated in the second direction to cause the actuator to remove the load.

9. The actuator of claim 7 wherein the eccentric forms the input to the orbital transmission and the second outer gear forms the output from the orbital transmission.

10. The actuator of claim 7 wherein the pinion gear system comprises a first pinion mounted on the motor output, a second pinion in mesh with the first pinion, and the second pinion meshing with the spur gear.

11. The actuator of claim 7 wherein the spur gear arrangement comprises a spur gear having internal teeth and a pinion mounted on the motor output and meshing with the internal teeth of the spur gear.

12. The actuator of claim 11 wherein a single pinion could be mounted on the motor output and mesh with the spur gear.

13. The actuator of claim 7 wherein the output member comprises a kidney pulley coupled to the output of the orbital transmission, the kidney pulley receiving a cable so that upon rotation of the kidney pulley in one direction, a load is applied to the cable, and upon rotation of the kidney pulley in the opposite direction, the load is released from the cable.

14. The actuator of claim 7 wherein the first outer gear is arranged in a gear housing, the housing receiving an input shaft which couples with the eccentric and the input shaft mounting the spur gear so that upon rotation of the spur gear, the input shaft and the eccentric are rotated.

15. The actuator of claim 14 wherein the housing and first input gear are fixed stationary relative to the input shaft and the eccentric and provide a control gear so that when the eccentric is rotated, the first orbit gear is caused to execute an orbit, which in turn causes the second orbit gear to execute an orbit, and the meshing of the second orbit gear with the second output gear, rotates the second output gear, to in turn rotate the kidney pulley.

16. The actuator of claim 15 wherein the second output gear carries at least one sensor for sensing rotary movement of the second output gear, and therefore rotary movement of the kidney pulley.

17. The actuator of claim 7 wherein the motor and the orbital gear box are arranged in side by side relationship within a casing.

18. A brake applicator for a vehicle, including:
a brake system for applying the brakes of a vehicle;
a cable connected to the brake system; and
a brake actuator engaging the cable for drawing in the cable to apply the brakes or feeding out the cable to release the brakes, the brake applicator having:
(a) an electric motor having a motor output;
(b) an orbital transmission having an input coupled to the motor so that the input can be driven by the motor;
(c) an output from which output rotary power is supplied; and
(d) an output pulley engaging the cable and connected to the output so that when the output rotates in one direction, the cable is drawn in to apply the brakes, and when rotated in the opposite direction, is paid out to release the brakes.

19. The brake actuator of claim 18 wherein the orbital transmission comprises:
(a) an eccentric;
(b) a first orbit gear mounted on the eccentric;
(c) a second orbit gear mounted for rotation on the eccentric and fixed to the first orbit gear;
(d) a first outer gear for meshing with the first orbit gear; and
(e) a second outer gear for meshing with the second orbit gear;
one of the eccentric and first outer gear forming an input to the orbital transmission, and one of the second outer gear and eccentric respectively, forming an output from the orbital transmission; and
an output member coupled to the output of the orbital transmission for applying a load.

20. The brake actuator of claim 18 wherein the brake actuator further includes a spur gear arrangement between the motor output and the input of the orbital transmission, and including a spur gear coupled to the input of the orbital transmission, and a pinion gear system meshing with the spur gear and driven by the motor output of the electric motor.

21. The brake actuator of claim 19 wherein the eccentric forms the input to the orbital transmission and the second outer gear forms the output from the orbital transmission.

22. The brake actuator of claim 20 wherein the pinion gear system comprises a first pinion mounted on the motor output, a second pinion in mesh with the first pinion, and the second pinion meshing with the spur gear.

23. The brake actuator of claim 20 wherein the spur gear arrangement comprises a spur gear having internal teeth and a pinion mounted on the motor output and meshing with the internal teeth of the spur gear.

24. The brake actuator of claim 23 wherein a single pinion could be mounted on the motor output and mesh with the spur gear.

25. The brake actuator of claim 19 wherein the output member comprises a kidney pulley coupled to the output of the orbital transmission, the kidney pulley receiving a cable so that upon rotation of the kidney pulley in one direction, a load is applied to the cable, and upon rotation of the kidney pulley in the opposite direction, the load is released from the cable.

26. The brake actuator of claim 19 wherein the first outer gear is arranged in a gear housing, the housing receiving an input shaft which couples with the eccentric and the input shaft mounting the spur gear so that upon rotation of the spur gear, the input shaft and the eccentric are rotated.

27. The brake actuator of claim 26 wherein the housing and first input gear are fixed stationary relative to the input shaft and the eccentric and provide a control gear so that when the eccentric is rotated, the first orbit gear is caused to execute an orbit, which in turn causes the second orbit gear to execute an orbit, and the meshing of the second orbit gear with the second output gear, rotates the second output gear, to in turn rotate the kidney pulley.

28. The brake actuator of claim 27 wherein the second output gear carries at least one sensor for sensing rotary movement of the second output gear, and therefore rotary movement of the kidney pulley.
